(19) United States
(12) Patent Application Publication
(10) Pub. No.: US 2025/0310220 A1
(43) Pub. Date: Oct. 2, 2025

(54) HIGH THROUGHPUT, LOW LATENCY LOOKUP TABLE SYSTEMS AND METHODS

(71) Applicant: Arista Networks, Inc., Santa Clara, CA (US)

(72) Inventors: Marc Durrenberger, Belrose (AU); Liam Toby Warburton, East Ryde (AU); Ryan Tavis Flux, Alderley (AU)

(21) Appl. No.: 18/622,427

(22) Filed: Mar. 29, 2024

(51) Int. Cl. H04L 43/028; H04L 49/901

(52) U.S. Cl. CPC H04L 43/028; H04L 49/901

(57) ABSTRACT

A hybrid lookup system includes a hash table, a collision FIFO, and an aging FIFO. An incoming entry or key and a hash or slice of the key is used as an index into the hash table. A collision counter is checked to determine whether the number of valid entries is no more than the depth of the hash table. If so, only the hash table is checked for matches to the entry; otherwise, both the hash table and collision FIFO are checked. New entries are looked up and concurrently stored in the least recently used slot of the hash table, in a corresponding indexed slot of the collision FIFO, and in an aging FIFO. Collision counters are incremented when corresponding entries are added and are decremented when corresponding entries are popped from the aging FIFO. In this way, the hybrid lookup system can achieve very low resource utilization.

### TECHNICAL FIELD

The disclosed embodiments relate generally to lookup tables, and more particularly to systems and methods for determining entries in a lookup table which provide high bandwidth while being resource efficient.

### BACKGROUND

In the context of monitoring network traffic, it is often necessary or desirable to monitor the traffic for purposes such as capturing the traffic, performing network analytics, and the like. It may also be desirable to deduplicate packets (i.e., eliminate duplicate packets) in the monitored traffic.

Data deduplication is a technique that can be used by network applications to deduplicate such packets. Existing data deduplication systems typically use fixed lookup tables. These fixed lookup tables store previously received packets and lookups are performed on the fixed lookup tables to determine whether newly received packets were previously received and stored in the fixed lookup tables. These existing data deduplication systems, however, are not well suited to handle fast entries and aging of the entries in the fixed lookup tables. Rather, they are better suited to more static data or post-processing of network traffic. Further, existing data deduplication systems use a large amount of field-programmable gate array (FPGA) and/or application-specific integrated circuit (ASIC) resources and require more and more space and routing resources as performance is increased.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features.

FIGS. 1A and 1B are high level diagrams illustrating the lookup of a single entry in a data structure and the identification of duplicates in a stream of entries in accordance with some embodiments.

FIG. 2 is a diagram illustrating a hybrid lookup system in accordance with some embodiments.

FIG. 3 is a high level flow diagram illustrating the lookup operations of a hybrid lookup system in accordance with some embodiments.

FIG. 4 is a high level flow diagram illustrating operations to insert entries in the hybrid lookup system in accordance with some embodiments.

FIG. 5 is a diagram illustrating the flow of data during a lookup in a hybrid lookup system in accordance with some embodiments.

FIG. 6 is a diagram illustrating the flow of data during concurrent lookup and insertion operations in a hybrid lookup system in accordance with some embodiments.

FIG. 7 is a diagram illustrating the expansion of deduplication logic in accordance with some embodiments.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

Embodiments of a hybrid lookup system disclosed herein leverage enabling technologies that may include some commonly used components and techniques such as hash tables, least recently used (LRU) method, and so on, but combine the components and techniques in a new and particular way. For instance, a sparsely populated hash table is utilized with an index based overflow (collision) First In, First Out (FIFO) data structure or memory element to achieve a solution that has very low resource utilization and is efficient for meeting constraints for FIFO timing and fitting within congested network devices such as FPGA-enabled switches, allowing the hybrid lookup system to be used for implementing a more efficient method to deduplicate packets. This practical application of the hybrid lookup system is further described below. The unique solutions disclosed herein can also improve scalability, enabling increases in the number of rows or overall entries in a hash table (which is referred to herein as the “depth” of the hash table) without sacrificing timing.

There are many instances in which there is a need for high bandwidth hash tables. For example, high bandwidth hash tables may be used in caching, learning applications, or general network filtering applications such as firewalls. Although the disclosed embodiments may be used in many different systems and applications, as a non-limiting example, the instant disclosure will focus on a FPGA-enabled network device with a network application that utilizes a hybrid lookup system having high bandwidth hash tables, a collision FIFO, and an aging FIFO to process packets in monitored network traffic. This example should be construed as illustrative, rather than limiting, of the various applications of the disclosed embodiments.

As alluded to above, the disclosed embodiments of a hybrid lookup system utilizes a combination of elements, including a hash table, a collision FIFO, and an aging FIFO, to rapidly and efficiently determine whether an entry corresponding to an incoming packet already exists and, if so, fetch some data from the entry. While the hash table might conventionally be considered as a “lookup table,” the hybrid lookup system utilizes the combination of the hash table, the collision FIFO, and the aging FIFO cooperatively to lookup entries and to handle collisions (e.g., hash collisions, discussed below) of the entries. Accordingly, references below to a “lookup table” in the disclosed embodiments should be construed to mean the combination of these components, unless otherwise indicated.

When a network packet (“packet”) is received (e.g., by a network application running on a FPGA-enabled switch), a hash function may be applied to the packet to generate a hash key (which is referred to herein as an incoming key). In such cases, an incoming key to the hybrid lookup system would already have been a hash key. As a non-limiting example, this hash key may, for example, be a 64-bit value. A 64-bit hash key is considered a huge key, so it is rather unlikely to have a hash collision with other keys. If the incoming keys all have a fixed size (e.g., 64 bits), the hybrid lookup system does not create a 64-bit hash key from each incoming key, but does hash it to create an index hash. As the whole, when an incoming key is a hash, it is pretty uniformly distributed. This allows the hybrid lookup system to take a portion of the hash key (which may be referred to herein as a “slice” of the hash key) and use it directly (e.g., to index an entry into the hash table and the collision FIFO to store the entry and/or to look up a corresponding existing entry). For example, if the hash table and the collision FIFO have 4096 rows, a 12-bit slice of a 64-bit hash key can be used to index the hash key into the hash table and the collision FIFO.

In some embodiments, an incoming key to the hybrid lookup system may not be a hash. In such cases, keys used in the hybrid lookup system may not be uniformly distributed. This means that the hybrid lookup system cannot take a slice of an incoming key and use it directly as an index hash. Rather, the hybrid lookup system would first generate a hash from the incoming key (for size reduction) and then take a slice of the hash thus generated for indexing a corresponding entry. This hashing can reduce collisions. For example, suppose the incoming keys happened to be incrementing numbers, taking the most significant 12 bits of each incoming key might result in hash collisions (i.e., identical entries), which would reduce the performance of the hybrid lookup system and, by extension, the underlying system. The hybrid lookup system maintains a collision counter and a preconfigured limit for each index that specifies the number of valid entries with the same index hash that can be stored in the hybrid lookup system. For a given index, if the collision counter is not more than the preconfigured limit, then it is only necessary to check the valid entries in the hash table to determine whether there is a match. Otherwise, both the hash table and the collision FIFO are checked to determine whether there is a match.

Matching entries in the hash table and/or collision FIFO are identified by comparing the full hash key to the hash keys stored in the valid entries. Since the bits of the slice are already known to be a match (since the entries at the index necessarily match these bits), alternative embodiments may compare only the remaining bits (e.g., the 52 bits not included in the slice) to determine whether the stored entries match the lookup entry.

In some embodiments, the hybrid lookup system can be used for purposes such as deduplication of a series of entries. For example, a stream of packets may be monitored to determine whether any of the packets are duplicates of other packets that have been recently transmitted or observed (if the hybrid lookup system performs internal processing and does not transmit the packets). In these embodiments, in addition to simply looking up hash key entries in the hybrid lookup system, the new entries that are being looked up are concurrently stored in the hybrid lookup system and looked up to determine whether they have been previously stored. If an entry was previously stored, the lookup will identify the entry in the hybrid lookup system and the entry will be identified as a duplicate. In response to identifying the entry as a duplicate, the corresponding duplicate packet in the packet stream can be identified and, if desired, removed from the stream.

A limited number of entries can be stored in the hash table at any given time, and entries may be aged out of the table. The entries may be aged out of the table either when they reach a threshold time in the table, or when the number of available entries in the table is exceeded. In the case of deduplicating packets in a packet stream, this limits the number of preceding packets in the stream that are considered when determining whether each packet is a duplicate.

Because a portion of the hash is used to index into the hash table, entries can be looked up very quickly, particularly in comparison to a simple linear search of a conventional lookup table. Additionally, as discussed above, the number of valid entries for each index hash in the hash table and the collision FIFO is tracked (e.g., via a collision counter), so that if the number of valid entries does not exceed the number of entries for the corresponding index hash in the hash table, it is not necessary to check the collision FIFO for matches.

This solution is very resource efficient while being able to provide high throughput, low latency lookups, insertions and deletions in the hash table, and also handle run-time hash collisions efficiently. Additionally, this solution is scalable and can be expanded with more resources to handle higher bandwidth and/or depth without causing difficulties in routing and timing, which is often a problem with existing systems.

As noted above, the disclosed embodiments can be used in a wide variety of applications. For instance, embodiments can be used for deduplication of entries in a stream of entries, rapidly looking up pages that are already in use in a hardware RAM caching system, speeding up search algorithms, MAC learning or routing tables within switches (which would eliminate the need for expensive dedicated content addressable memories (CAMs)), and many other applications. Generally, the disclosed embodiments can be used in any application where there are lookups that are reasonably randomized through the use of a hash. These embodiments are particularly useful in handling high insertion and deletion rates with run-time resolution of collisions, while maintaining low latency and high throughput lookups.

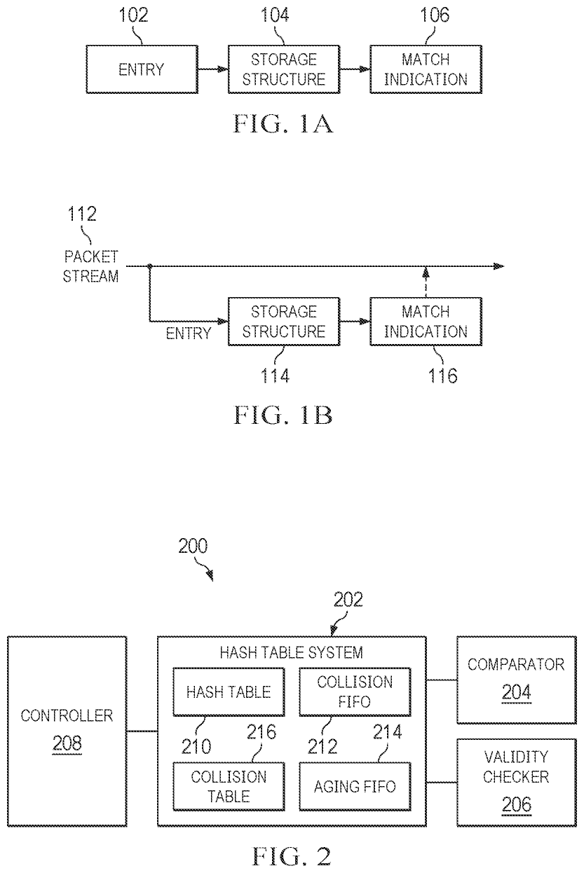

The general problem addressed by the disclosed embodiments is the difficulty in performing fast lookups of data stored in a table. “Table,” as used here, refers to any data structure that is used to store data and that is subject to lookups of the stored data. The generalized lookup of data in a data structure is illustrated in FIG. 1A, which shows that an entry 102 is obtained and compared to entries that are stored in a data structure 104 in order to generate an indication 106 of whether or not entry 102 is stored in data structure 104.

Typically, hash tables are used for data structure 104 because hash tables allow entries in the table to be quickly looked by based on the ability to index into the table using a hash key. The existing art for hash tables, however, doesn't deal well with dynamic situations in which very fast entries and aging of the table are necessary. Conventional hash tables and associated techniques work better if the tables are more static.

Referring to FIG. 1B, a more dynamic situation is illustrated. In this scenario, a stream of Ethernet traffic 112 comprising a series of packets is monitored. Some of the packets in the stream could be identical to each other, so it is necessary to determine whether each packet is a duplicate of the preceding packets. As each packet is detected, a signature or a fingerprint of the packet is stored in data structure 114. This will allow the signatures of later-received packets to be checked against the data structure to determine whether they are duplicates of the stored packet.

In addition to storing the signature of the packet in the data structure, the packet signature is checked against the data structure to determine whether the packet signature matches any other packet signature that is stored in the data structure (representing corresponding packets that were previously detected in the stream of packets). An indication 116 of whether the packet signature matches any of the packet signatures that were already stored in the data structure is then generated. A match indicates that the corresponding packet in the packet stream is a duplicate and, in response to the indication, corresponding action may be taken with respect to the duplicate packet (e.g., the duplicate packet may be removed from the stream).

Conventionally, handling the deduplication case would typically involve a straightforward approach in which each packet in a monitored packet stream would be stored in a lookup table, and then the lookup would involve searching through the table until a matching entry is found, or until the entire table has been searched without finding a match. Since the lookup could potentially require that every single entry in the table be searched for every single packet lookup, this approach generally takes a great deal of time. Even if comparisons of multiple entries were performed each time the entries in the table were looked up, this approach is resource intensive, so it doesn't scale well to the speeds at which packets are transmitted Ethernet traffic.

The disclosed embodiments use hash tables in a way that enables hash table lookups while still being able to ensure high throughput that is needed for more specific cases such as deduplicating packets in Ethernet traffic. These embodiments enable insertion of entries into hash tables and provide ways to handle collisions between entries in the hash tables, which normally make it difficult to insert the entries in the tables.

Thus, the disclosed embodiments employ a hybrid approach that partially uses hash tables and partially uses other types of memories (including a collision FIFO and, in some embodiments, an aging FIFO) to handle the collisions. These embodiments enable entries to be stored in the hash table and looked up on the fly at high throughputs, where traditional solutions require that the entries (e.g., packets in monitored Ethernet traffic) be recorded so that post-processing can be performed on the recorded entries.

Referring to FIG. 2, a diagram illustrating a hybrid lookup system 200 in accordance with some embodiments is shown. As alluded to above, the hybrid lookup system may be implemented on an FPGA-enabled network device and used by a network application to process packets in monitored network traffic. In this embodiment, the hybrid lookup system 200 has a hash table system 202 that includes a hash table 210, a collision FIFO 212, an aging FIFO 214, and a set of collision counters 216.

Hash table 210 has storage locations that are organized logically into multiple rows that are addressable by corresponding index values. For example, in one embodiment, the hash table has 4096 rows that are addressed by a 12-bit index. Other embodiments may have more or less rows (e.g., 1024 rows that are addressable by a 10-bit index, 8192 rows addressable by an 13-bit index, etc.)

Each row of the hash table may have one or more associated storage locations. In one embodiment, each row has four storage locations, all of which are associated with the same index value, so that four entries can be stored in the row. As with the number of rows, the number of storage locations in each row may vary from one embodiment to another.

In operation, collision FIFO 212 functions like a FIFO on writing, where the write address of the FIFO increments on each new entry (and increments the count for that entry's index). On aging out of an entry, it also functions like a FIFO and will pull out the last written entry (and decrement the count for that entry's index). Alongside this, the collision FIFO has a ‘pointer’ memory that stores the two most recent write addresses for each index. So, when a new entry is added, the FIFO will store the older of the two write addresses in the FIFO memory (alongside the entry data), and replace this older address in the ‘pointer’ memory with the new address. For the searching operation, the collision FIFO is supplied with the index to search on. It looks up the ‘pointer’ memory to determine the addresses to start on and reads the entry to determine the next address to compare the hash against. It does this for half the count for the index to traverse the whole list. As a non-limiting example, the FIFO can be implemented on a dual-port memory (e.g., a dual-ported random access memory (RAM)). This allows the FIFO to use two entries to advantageously halve the search time by looking up an entry on both ports of the RAM simultaneously.

As entries are stored in hash table 210, the storage locations in a particular row of the hash table are filled. As the corresponding entries are aged out or ejected from the aging FIFO (as will be explained in more detail below), the entries are invalidated in the hash table, making the corresponding storage locations in the hash table available for storing new entries.

When a new entry is to be stored in hash table 210, it may be the case that all of the storage locations in the corresponding row are filled with valid entries, so that the entry cannot be stored in the row. This is referred to as a “hash collision” or “collision” in the hash table. In the case of a collision, the entry is stored in the corresponding FIFO memory (i.e., the row of collision FIFO 212 having the same index as the row of the hash table). Entries stored in collision FIFO 212 are valid when stored in the FIFO, but may be invalidated when they are aged out or ejected from aging FIFO 214. There might be a case when all of the storage locations in a row of collision FIFO 212 are filled with valid entries. If a hash row is full, the LRU is evicted (in accordance with the LRU method as known to those skilled in the art) and replaced with a new entry. The collision FIFO is written with each entry as they come in. The collision FIFO is sized so that it will never overflow . . .

As noted above, aging FIFO 214 is used to determine how long entries are stored in the hash table system 202. Each time a new entry is stored in hash table 210 and collision FIFO 212, the entry is also stored in aging FIFO 214. When aging FIFO 214 has been filled with entries, each new entry that is stored in the aging FIFO pushes out (ejects) the oldest entry. Aging FIFO 214 may also be configured to advance its entries on a time basis, so that no entry stays in the aging FIFO for more than a set amount of time. When an entry is ejected from aging FIFO 214, the corresponding entry is invalidated in hash table 210 and collision FIFO 212 so that the corresponding storage locations are made available to store new entries.

The number of entries in aging FIFO 214 can vary from one embodiment to another. The specific number of entries in the aging FIFO can depend on the number of entries that are expected to be in the entire hash table within the aging time. If the aging FIFO is too small, it will fill up quickly, and the hash table will have very few valid entries, so the resources used for the hash table may be underutilized. On the other hand, it is desirable for the hash table to be relatively sparsely populated so that it is unlikely that the hash table will overflow and require lookups in the collision FIFO.

Another consideration for the design of aging FIFO 214 is that the system must meet timing requirements for handling the anticipated throughput. The larger the aging FIFO, the more memory and address space will be required, which makes it more difficult to meet the timing requirements.

Considering a non-limiting use-case example of a hash table that has 4096 rows and is four entries deep, there are 16,384 storage locations in the hash table. If the aging FIFO is configured to store the full number (16,384) of entries in the hash table, the hash table would likely overflow, as they are somewhat randomly distributed among the 4096 indexed rows. Since it is desirable to prevent the hash table from overflowing, the aging FIFO may instead be configured to store 4096 entries (one quarter of the possible entries in the hash table) to balance the competing concerns of having a large enough number of entries against which matches are determined and maintaining a sparsely populated hash table.

As illustrated in FIG. 2, hash table system 202 also includes a set of collision counters 216. The collision counters are used to determine whether, when an entry is looked up in hash table 210, there are additional valid entries that have overflowed the hash table and are stored in collision FIFO 212. In other words, the collision counters are used to determine whether a lookup can be done on hash table 210 alone, or whether it is also necessary to check collision FIFO 212 as well.

Collision counters 216 include an individual counter for each row of hash table 210. Thus, if hash table 210 has 4096 rows, there are 4096 individual collision counters, where each individual collision counter is associated with a corresponding row of the hash table. Regardless of the depth of the hash table, there is a single individual collision counter associated with each row of the hash table for tracking the number of entries that can be stored in a corresponding row.

It should be noted that, while there is an individual counter for each row of the hash table, the individual counters may be “individual” in a virtual or logical sense. In other words, the counters need not be physically separate. They may instead be designated storage locations in a single memory or in shared memories that are used to maintain the individual counter values of the individual counters.

When an entry is received (e.g., by controller 208) to be looked up in hybrid lookup system 200, the index of the entry is determined and used to identify the corresponding row of hash table 210 and the corresponding individual counter of the set of collision counters 216. The value of the collision counter is compared to a preconfigured limit and, if the value of the collision counter is no more than the preconfigured limit, all of the valid entries in hash table system 202 are stored in hash table 210, so it is only necessary to check the hash table for a match of the new entry-it is not necessary to check collision FIFO 212 for a match. If, on the other hand, the value of the collision counter is greater than the preconfigured limit, not all of the valid entries in hash table system 202 are stored in hash table 210—at least one is stored in collision FIFO 212. It is, in this case, necessary to check both the hash table and the collision FIFO for a match of the new entry.

It should be noted that the collision counters may alternatively maintain a count of the number of valid entries only in the collision FIFO. In this case, rather than comparing the counter value to the preconfigured limit, the counter value is examined to determine whether it is zero or non-zero. If the counter is zero, there are no valid entries in the corresponding row of the collision FIFO, so it does not need to be checked for a match. If the collision counter value is non-zero, it contains one or more valid entries, so it needs to be checked for a match.

If a match for the entry is found in the hash table or collision FIFO, the number of valid entries does not change, so there is no need to update the collision counter. If no match is found, the new entry represents an additional valid entry in the system, so the collision counter is incremented. When one of the entries in the aging FIFO ages out or is ejected, the corresponding entry in the hash table and/or collision FIFO is no longer valid, so the corresponding individual collision counter is decremented.

Hybrid lookup system 200 includes a comparator 204 that is coupled to hash table system 202 and is configured to compare new entries to entries that are already stored in hash table 210 and collision FIFO 212. The comparator functions are described in detail below. Hybrid lookup system 200 also includes a validity checker 206 that is configured to determine the validity of entries that are stored in hash table 210 and collision FIFO 212. The validity information is used for purposes of determining which storage locations in the hash table and the collision FIFO are available for storing new entries. Hybrid lookup system 200 further includes a controller 208 that manages the operation of the various components of the hybrid lookup system and also handles the generation of hash keys and slices of the hash keys that are used in the storage and comparison of entries in the hybrid lookup system.

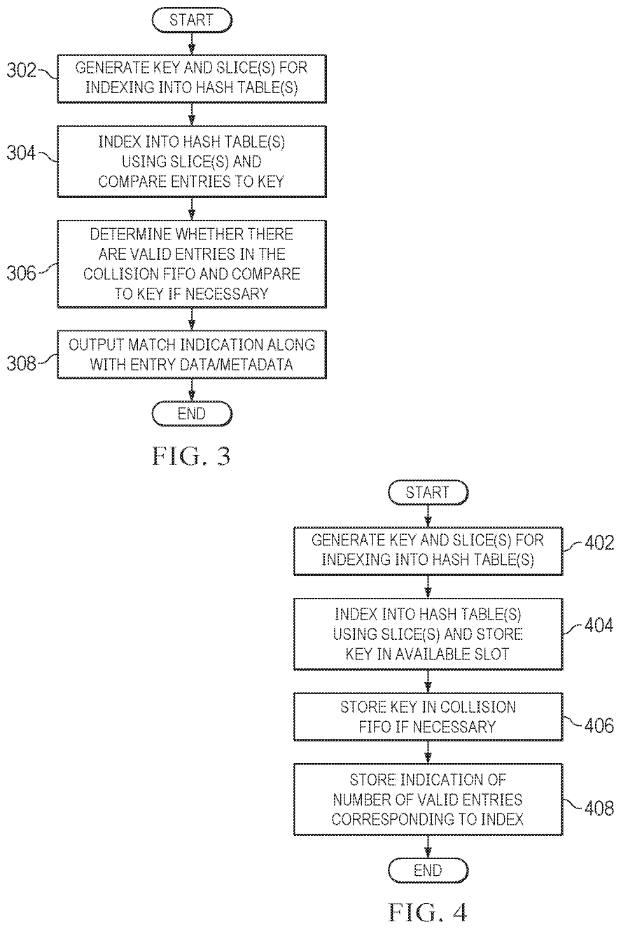

Referring to FIG. 3, a flow diagram illustrating the lookup operations of the hybrid lookup system at a high level is shown. The detailed operation of a more specific example of a hybrid lookup system is provided below.

At step 302 of FIG. 3, a key is generated by hashing a packet, and a slice of the key is produced by hashing or taking selected bits from the key, as described above. If the hybrid lookup system is multiple entries deep using multiple one-deep hash tables, slices for each of the hash tables are produced for use with the corresponding one-deep hash tables. If the lookup table is used for information other than a stream of packets, the relevant pieces of data are hashed in the same manner to generate the key and slice for use in the hybrid lookup system.

At step 304, the generated slice is used as an index to select a specific row of the hash table at which the key (or non-slice portion thereof) may be stored and the key is compared to an entry in the row, if valid, to determine whether there is a match. If the hybrid lookup system is multiple entries deep, the multiple slices corresponding to the respective one-deep hash tables are used as indices to select the corresponding specific rows of the hash tables at which the key (or non-slice portion thereof) can be stored, and any valid entries in the selected rows are compared to the key to determine whether there is a match.

At step 306, it is determined whether there are valid entries in the collision FIFO and if so, any such valid entries are compared to the key to determine whether there is a match. This may be determined, for example, by examining the value of the corresponding collision counter to determine whether the number of valid entries corresponding to the index (or indices, if there are multiple one-deep hash tables) exceeds the depth of the hash table(s). If the number of valid entries does not exceed the depth of the hash table(s), there is no need to check the collision FIFO for possible matches.

At step 308, an indication of whether a match has been found is output. The match may have been found in either the hash table(s) or the collision FIFO. If the lookup system is used for a purpose such as deduplication of packets in a monitored traffic stream, the match indication may be used to remove identified duplicates from the stream.

Referring to FIG. 4, a flow diagram illustrating, at a high level, operations to insert entries in the hybrid lookup system is shown. The detailed operation of the more specific example of the hybrid lookup system is provided below.

At step 402, a key is generated by hashing a packet, and a slice is produced by hashing or taking selected bits from the key. These are the same key and slice that are generated at step 302 to perform the lookup. Again, if the hybrid lookup system uses multiple one-deep hash tables, corresponding slices for each of the hash tables are produced. The key and slice(s) may be generated in the same manner, regardless of whether the entries correspond to packets or other types of data.

At step 404, the appropriate slice is used to index into the hash table, and the key is stored in an available slot of the hash table. If multiple one-deep hash tables are used, the corresponding slices are used to index into the respective tables and the key is stored in an available slot of one of the hash tables.

At step 406, the key may be stored in a slot of the collision FIFO. In some embodiments, the key is always written to both the hash table and the collision FIFO. The key is stored in the least recently used slot of the hash table to effectively bump out the oldest entry. This guarantees that the hash table will always have the four newest entries for each index, and older entries can be found in the collision FIFO. In alternative embodiments, other mechanisms can be used to determine whether the slots of the hash table are filled and whether it is necessary to store an entry in the collision FIFO.

At step 408, the number of valid entries corresponding to the index (the slice(s) of the key) is stored. In some embodiments, this is done through the use of a collision counter that is incremented when an entry corresponding to a particular index is stored and is decremented when an entry corresponding to the particular index is invalidated (e.g., aged out of the aging FIFO).

Following is an example embodiment of a hybrid lookup system. In this embodiment, the system is configured for deduplication of a stream of packets (e.g., a stream of Ethernet traffic).

The packets may have varying sizes and the stream of packets has a high throughput (e.g., as high as 100 Gbps).

The system monitors the stream of packets and, for each packet, performs a lookup of an entry, an insertion of the entry into the hybrid lookup system, and a removal of an entry from the hybrid lookup system. Because of the high throughput of the system, the entries in the hybrid lookup system are very short lived (i.e., they remain in the table for a very short period of time before they are aged out of the table).

The hybrid lookup system does not store the packets themselves, but instead hashes each packet using a CRC hash to generate a corresponding 64-bit key. (Although the key is a hash of the packet, it will be referred to herein as a key to avoid confusion with another hash-a hash or “slice” of the key.) The key generated by the hash function has 64 bits, regardless of the length of the packet. The key serves as a fingerprint or signature of the packet. It is the key, rather than the packet itself that is stored in the hash table. As discussed above, a 64-bit hash key is used as a non-limiting example. Many hash functions can be used to generate hash values that are uniformly distributed across all the rows in a hash table (or “buckets” corresponding to the rows, as described below). That is, each hash value is equally likely to be assigned to any input data, so that it is rather unlikely to have a hash collision with other hash values.

After the 64-bit key is generated, a hash is performed on the key to produce a 12-bit hash that is referred to as a “slice” of the key. The slice can be an actual hash of the key, but since the 64-bit key is already a hash, the slice can be produced by taking a unique set of the bits of the key. In doing so, a good distribution of the entries can be maintained (i.e., the slice thus produced is unlikely to have a hash collision with slices produced from other 64-bit keys). The 12 bits of the slice may comprise contiguous, sequential bits of the key (e.g., bits 0-11), or the bits may be arbitrarily selected from the hash key (e.g., bits 2, 5-7, 31, 39, 45-49 and 58). These same bits are used to produce the slice from the key for each packet.

The 12-bit slice is used to index into (directly address into) the hash table and collision FIFO, each of which has 4096 rows. If the hash table and collision FIFO were designed to have 1024 rows, a 10-bit slice would be produced as an index.

In some embodiments, the cells of the hash table can be created using Ultra-RAM (URAM) cells, useful for FPGA-enabled devices with URAMs. The URAM cells are 72 bits wide and have 4096 rows (addressable by the 12 bits of the slice). The URAM cells are dual-port synchronous memory, for which operations on port A are executed before operations on port B. In this embodiment, the 52 bits of the key that are not included in the slice are stored in the memory. These 52 bits form the entry in the hash table and/or collision FIFO and are used to determine a match between an entry stored in the cell and a newly received lookup entry.

A one-bit valid flag is stored in the cell to indicate whether the stored entry is valid (e.g., “1” indicates valid and “0” indicates invalid). The cells and corresponding valid flags are initialized to “0” on startup, so none of the cells initially store valid entries. A stored entry must be valid to be a match for a lookup entry. To facilitate aging of the stored entries, a unique sequence number is kept in each row.

The hash table is four entries deep, so for each index of the hash table, there are four slots in which entries can be stored. The four-deep hash table is formed using four one-deep hash tables in parallel. Each of the one-deep hash tables has 4096 indexed slots that are addressed by corresponding 12-bit slices of the 64-bit key. In this embodiment, each one-deep hash table is indexed using a different slice of the entry. For example, the four one-deep hash tables may be indexed by slices comprising bits 0-11, 4-15, 22-33 and 40-51, respectively. The use of different slices of the 64-bit key provides different distributions of the entries in the different one-deep hash tables, which may reduce the likelihood of collisions within the overall, four-deep hash table. For example, two keys that have the same bits in a first slice and would therefore collide in a corresponding one-deep hash table may have different bits in a second slice and therefore would not collide in a corresponding, second one-deep hash table.

As noted above, the hash table is used in conjunction with a collision FIFO. In the event that there is a collision between a new entry and entries in all of the hash cells in the row corresponding to the new entry, the new entry is loaded into the collision FIFO. This guarantees that the system can deal with any collisions.

The collision FIFO is a special FIFO that also has a search interface. If a search of the collision FIFO is initiated, the collision FIFO de-asserts ready (to block push and pop operations) and starts searching the valid contents of the FIFO. The collision FIFO is constructed using dual-port URAM and can be searched from both ports at once (with each port searching alternate entries). The search starts with the write pointer at-1, so that more recent duplicates will be found sooner.

In order to reduce the number of lookups into the collision FIFO (particularly lookups into the collision FIFO when no entries have overflowed from the hash table row into the corresponding collision FIFO row), a collision counter or bucket counter is used to indicate potential entries in FIFO. There is one collision counter for each row of the hash table/collision FIFO. The collision counter may be referred to as a bucket counter because the counter indicates the number of valid entries in the “bucket” in both the row of the hash table and the corresponding row of the collision FIFO. If the multiple-entries-deep hash table uses different slices for the different one-deep hash tables, a corresponding counter would be used for each of the one-deep hash tables.

When an entry is inserted into a row, the collision counter corresponding to this index is incremented, and when an entry is removed (invalidated), the collision counter is decremented. On lookup of a new entry, the collision counter at the corresponding index is checked. As described above, each index has a preconfigured limit that specifies a number of valid entries with the same index hash that can be stored. Thus, if the value of the collision counter is not more than the preconfigured limit for the corresponding index, then it is only necessary to check the valid entries in the hash table to determine whether there is a match (i.e., a match for the lookup entry cannot be in the collision FIFO), which eliminates the need to search the collision FIFO.

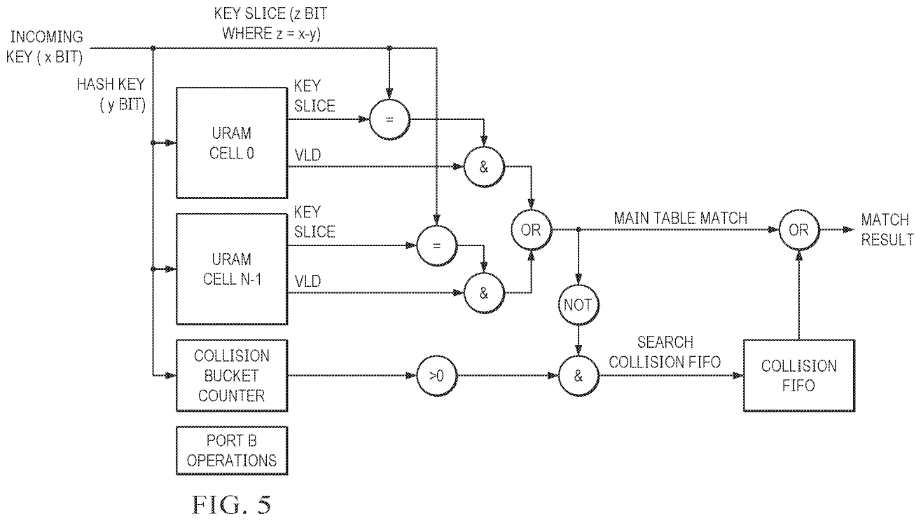

Table lookups are performed in a straightforward manner which is illustrated in FIG. 5. On a first clock cycle, the 12-bit slices of an incoming key are used to lookup (index into) all of the corresponding slots on the hash tables in parallel. In this embodiment, each of these lookups is done using a different 12-bit slice of the incoming key. The collision counter and the entries for the hash tables are also looked up in parallel using the corresponding slices of the 64-bit key.

On the next clock cycle, for each slot in each hash table, the data stored in the slot (52-bits) is compared to the 52 non-slice bits of the incoming key to determine whether they match. The valid flag of the entry (“VLD”) stored in each slot is also checked to determine whether the entry is valid. In the same clock cycle, the corresponding counter values are read, and a flag is created to indicate whether or not there is a need to search the collision FIFO.

On the next clock cycle, the results from the comparisons of each slot in the hash tables and the collision counters are combinatorially reduced. If there is a match in any of the hash table slots, there is a duplicate of the incoming entry in the hash tables, and there is no need to search the collision FIFO. If there are no matches from the slots of the hash tables and the collision counters are zero (i.e., there are no corresponding entries in the collision FIFO), there is no duplicate of the incoming entry, and there is no need to search the collision FIFO. If there are no matches from the slots of the hash tables, but the collision counter indicates that there are corresponding entries in the collision FIFO, all other operations on the collision FIFO are blocked and a search is initiated on the collision FIFO. This operation will continue until the search finds a match in the collision FIFO corresponding to the incoming entry, or the search reaches the end of the collision FIFO contents. The number of required clock cycles will be (FIFO_level/2)+C, where C is two or three cycles to fill the search pipeline.

As described above, operations on port A of the URAM are executed before operations on port B of the URAM. In this case, port B of the URAM is used for lookups to get write-through from port A, even though this port has a much slower clock to output. In order to meet the desired timing, there are only two clock cycles to perform the lookup and get a result. Consequently, the compare function is preferably performed directly on the entry read out of the URAM before it is registered. This allows the logic feeding the state of the system to be relatively simple, with one flag from each hash table slot and the collision counter.

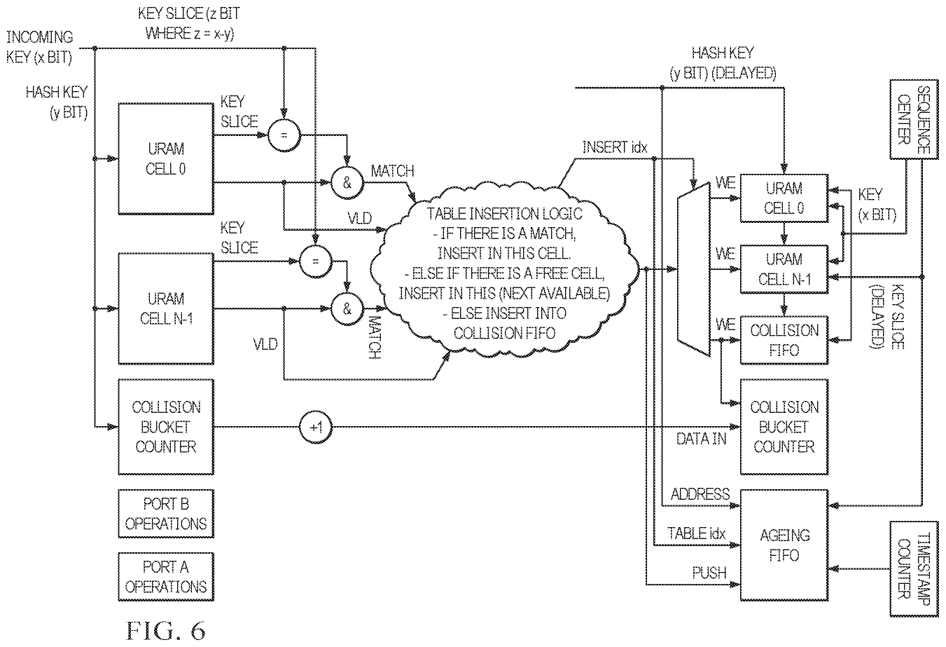

Insertion of entries with concurrent lookups in the hybrid lookup system are illustrated in FIG. 6. Table insertions are made into port A of the hash tables on the cycle at which the result from that lookup is available. In the same cycle, a potential next key is looked up from port B. As a result, if the next lookup is a duplicate of the entry currently being inserted into the hybrid lookup system, the port A operation will occur first and the updated contents will be read out of port B on the next cycle.

Information from the lookup is used to determine how the entry will be inserted in the hybrid lookup system. In order to increase the table efficiency, as well as reduce the probability of collisions, duplicates are not entered into the table more than once. Instead, the existing entry is updated.

Depending on the results of the lookup, the following insertions can occur. If there is a match from a hash cell, the incoming entry is re-inserted into the same slot containing the matching entry. The entry in the slot is updated by updating the sequence number of the entry in the slot. If there was not a match in the hash tables for the incoming entry, but one of the hash tables has a free slot, that slot is populated with the incoming entry. If all slots in the hash tables are populated, then the incoming entry is inserted into the collision FIFO and the corresponding collision counter is incremented. In the event that a match is found in the collision FIFO, it is necessary to insert an additional entry in the FIFO since entries in the FIFO must be removed in order. If a slot in one of the hash tables has become free, the entry can be inserted in the free slot. Otherwise, the entry needs to be inserted again into the collision FIFO and the corresponding collision counter needs to be incremented again.

For every entry inserted into a slot of the hash tables or the collision FIFO, an entry is inserted into the aging FIFO. This includes the entry indices for all the hash cells and the collision counter, as well as a sequence number which is used for aging and removing entries.

Entries are short lived in the table and need to be removed at an average rate of approximately one entry per packet. Entries are removed either because the number of entries in the table has reached a set number of entries, or because the entries have been in the table for longer than the configurable aging period. The number of FIFO entries and the output of the FIFO (aging information for the oldest entry in the table) are monitored. If the number of entries exceeds the set number, the oldest entry is marked for removal. If the timestamp for an entry is older than the configurable aging time, the entry is marked for removal.

Once an entry has been marked for removal, a check needs to be performed to ensure that the entry has not been updated (i.e., re-inserted into the table). This is done by reading the entry and comparing the sequence number of the entry with the one from the aging FIFO. If it is the same, this indicates the entry has not been updated, and it can be removed by setting the validity flag to “invalid” (e.g., writing “0” to the validity flag).

If the sequence number is different, this indicates that this entry has been updated and should not be removed from the table. In this case, the aging FIFO is popped, but no removal is performed in the table. In the case that the entry resides in the collision FIFO, it will always be removed, so it is not necessary to check any sequence numbers. It is necessary, however, to read the collision counter so that it can be decremented. In this case, the removal is performed by popping the collision FIFO and decrementing the corresponding collision counter.

In some embodiments, the design may be modified so that the collision FIFO is replaced by a table that has a linked list of previous values. In this case, the table tracks the last address written for each hash index and creates a linked list in a RAM. Searches then start at the last address used by the hash index and only traverse that hash (rather than the whole RAM, as in a searchable FIFO). The collision counters are then moved into the FIFO itself in order to only compare as far back as it needs. As the counters are used, there is no need to terminate the list, so no extra write operations are needed. In this design, the FIFO must never be overflowed so that the aging FIFO can ensure that the FIFO gets cleaned out. To save on resources the indexed collision FIFO will only perform one operation at a time (i.e., read/write/search). This allows all of the counters and logic to be pushed into RAM access and simplifies the design.

In some embodiments, the design of the system may be modified to operate for duplicates. One issue with some designs is that if a collision counter for an index becomes full and a duplicate occurs within an entry in the collision FIFO, then every time that duplicate occurs, it will need to look into the collision FIFO. This will consume excess clock cycles each time the duplicate occurs and it is therefore likely that it will not meet the desired performance.

With the design described in the example above, hitting the collision FIFO with the indexed table will result in a minimum of 4 clock cycles. The length of time for a given occurrence depends upon the number of entries in the index that has overflowed (3+ceil (num_entries/2)). The “ceil” or ceiling operation is applied here to round the value up to the next whole number.

Ideally, it is desirable for the duplicates to be found in the hash table. One way to get around this is to always write to both the collision FIFO and the hash table when there is space available, or when a match has been found. The hash table can use a LRU scheme to ensure that the latest hashes are always in the hash table.

The aging logic pops off the collision FIFO, but also checks the hash table for a match and invalidates it. The collision FIFO will be full all the time, but the indexed searching causes the search time to be small. Since the collision FIFO is full, there is a two clock cycle penalty (from the four entries in the hash table) each time a search is needed. Searches only occur when there are more entries indicated by the collision counter than valid bits in the hash table.

The logic for this embodiment uses the indexed collision table from above. The logic for a new key coming in becomes: Write to the collision FIFO; write to the hash table (evicting the least recently used entry). The LRU logic (for each hash index) is updated on any write to the hash table: the LRU table has the next available hash entry for each hash index; on aging, the aged entry becomes the LRU; on key writing, the written entry becomes the most recently used (i.e., last in line to be evicted). The aging logic then becomes (when an entry needs to be aged): pop off the collision FIFO; invalidate a match entry on the hash table.

This scheme is desirable for a balanced approach. Transferring between the hash table and collision FIFO will break overall continuity of the collision FIFO and mean more complex schemes are needed for taking care of the aging, but more importantly the restriction of the number of active entries in the table becomes much more complicated (in terms of both logic and timing).

Some embodiments may allow parallel depth expansion. Rather than increasing the FIFO depth by using higher depth URAMs (i.e., by cascading the URAMs), the depth may be increased by providing multiple parallel instances of the above logic which run in parallel. This avoids timing issues as the RAMs are cascaded and also allows better performance because the tables run in parallel, allowing faster lookups. As an example, if one of the tables is slow to perform the search, other tables are able to continue running and buffer up results. Once the delayed table has finished, the other tables' queued up results can be read in on every clock cycle.

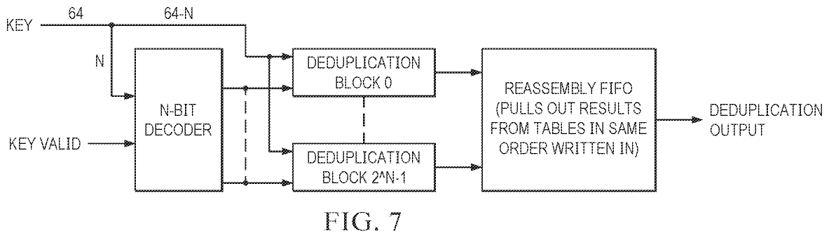

The parallel depth expansion is enabled by using bits of the key (outside of the hash index used by the table) to select which table to use. The tables are therefore working on orthogonal hash keys so that they do not depend on each other. Logic before the parallel tables directs the incoming hash key to the appropriate table. Logic after the parallel tables then puts the results back into the order in which they arrived. This is illustrated in FIG. 7.

In this disclosure, specific embodiments have been described with reference to the accompanying figures. In the above description, numerous details are set forth as examples. It will be understood by those skilled in the art, and having the benefit of this Detailed Description, that one or more embodiments described herein may be practiced without these specific details and that numerous variations or modifications may be possible without departing from the scope of the embodiments. Certain details known to those of ordinary skill in the art may be omitted to avoid obscuring the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as by the use of the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

As used herein, the phrase operatively connected, or operative connection, means that there exists between elements/components/devices a direct or indirect connection that allows the elements to interact with one another in some way. For example, the phrase ‘operatively connected’ may refer to any direct (e.g., wired directly between two devices or components) or indirect (e.g., wired and/or wireless connections between any number of devices or components connecting the operatively connected devices) connection. Thus, any path through which information may travel may be considered an operative connection.

While embodiments described herein have been described with respect to a limited number of embodiments, those skilled in the art, having the benefit of this detailed description, will appreciate that other embodiments can be devised which do not depart from the scope of embodiments as disclosed herein.

What is claimed is:

1. A system for rapid identification of entries in a lookup table, the system comprising:
a hash table;
a collision First-In-First-Out (FIFO) memory;
an aging FIFO memory; and
a controller adapted to:
receive a stream of network packets; and
for each respective packet in the stream of network packets, perform a lookup operation that comprises:
generating a hash key of the respective packet;
selecting a portion of the hash key as an index;
selecting a row of the hash table using the index;
determining whether the hash key matches any entry in the row selected using the index; and
determining, by comparing a value of a collision counter and a preconfigured limit for the index, whether to search the collision FIFO memory for possible matches.

2. The system of claim 1, wherein the controller is adapted to store the hash key in an entry of the hash table which is a least recently used (LRU) entry corresponding to the index.

3. The system of claim 1, further comprising, for each index of the hash table, a corresponding counter that tracks a number of valid entries in the hash table and in the collision FIFO memory corresponding to the index.

4. The system of claim 1, wherein the hash table comprises one of a plurality of hash tables, wherein each of the plurality of hash tables is indexed according to a corresponding unique portion of the hash key.

5. The system of claim 4, wherein the hash key comprises a 64 bit value, and wherein the unique portion of the hash key used to index each of the plurality of hash tables comprises a unique set of 12 bits of the 64 bit value.

6. The system of claim 1, wherein the hash key is stored in the hash table, in the collision FIFO memory, and in the aging FIFO memory concurrently and wherein the hash key is stored prior to determining whether the hash key matches any entries in the hash table and in the collision FIFO memory.

7. The system of claim 1, wherein, in response to determining that a number of valid entries in the hash table and the collision FIFO memory is not more than a number of entries in the hash table for each index of the hash table, the controller is further adapted to search only the hash table for a match of the hash key.

8. The system of claim 1, wherein, in response to determining that a number of valid entries in the hash table and the collision FIFO memory is more than a number of entries in the hash table for each index of the hash table, the controller is further adapted to search the hash table and the collision FIFO memory for a match of the hash key.

9. The system of claim 1, wherein, in response to determining that there is not a match for the hash key, the controller is further adapted to store the hash key in the hash table and provide an indication in the hash table that the hash key stored in the hash table is valid.

10. The system of claim 1, wherein, in response to determining that there is a match for the hash key, the controller is further adapted to provide an indication in the hash table that the hash key stored in the hash table is invalid.

11. The system of claim 1, wherein the controller is further adapted to remove the respective packet from the stream in response to determining that there is a match for the hash key.

12. A method for rapid identification of entries in a lookup table, the method comprising:
receiving a stream of entries; and
for each entry:
generating a hash key of the entry;
storing, in a memory, the hash key in an entry of a hash table at an index corresponding to a selected portion of the hash key;
storing the hash key in a collision First-In-First-Out (FIFO) memory;
determining a number of valid entries in the hash table and the collision FIFO;
in response to determining that number of valid entries in the hash table and the collision FIFO memory is no more than a number of entries in the hash table for each index, searching only the hash table for a match of the hash key;
in response to determining that number of valid entries in the hash table and the collision FIFO memory is more than the number of entries in the hash table for each index, searching the hash table and the collision FIFO memory for a match of the hash key;
in response to determining that there is no match for the hash key, providing an indication in the hash table that the hash key stored in the hash table is valid; and
in response to determining that there is a match for the hash key, providing an indication in the hash table that the hash key stored in the hash table is invalid.

13. The method of claim 12, wherein a controller stores the hash key in an entry of the hash table which is a least recently used (LRU) entry corresponding to the index.

14. The method of claim 12, further comprising, for each index of the hash table, tracking with a corresponding counter a number of valid entries in the hash table and in the collision FIFO memory corresponding to the index.

15. The method of claim 12, wherein the hash table comprises one of a plurality of hash tables, wherein each of the plurality of hash tables is indexed according to a corresponding unique portion of the hash key.

16. The method of claim 12, wherein the collision FIFO memory is implemented as a table that tracks last address written for each index and has a linked list of previous values in a random access memory.

17. The method of claim 12, wherein the hash key is stored in the hash table, in the collision FIFO memory, and in the aging FIFO concurrently and wherein the hash key is stored prior to determining whether the hash key matches any entries in the hash table and in the collision FIFO memory.

18. A method for rapid identification of entries in a lookup system, the method comprising:
receiving an entry;
generating a hash key of the entry;
generating an index hash based on the hash key;
indexing into a hash table and a corresponding collision FIFO stored in a memory;
determining a number of valid entries in the hash table and in the corresponding collision FIFO at slots corresponding to the index hash;
in response to determining that the number of valid entries in the hash table and the collision FIFO is no more than a number of entries in the hash table corresponding to the index hash, searching only the hash table for entries that match the hash key; and
providing an indication of whether a match is found in at least one of the hash table and the collision FIFO.

19. The method of claim 18, wherein determining the number of valid entries in the hash table and in the corresponding collision FIFO at slots corresponding to the index hash comprises, for each index of the hash table, tracking, in a corresponding counter, a number of valid entries in the hash table and in the collision FIFO corresponding to the index.

20. The method of claim 18, further comprising:
in response to determining that the number of valid entries in the hash table and in the collision FIFO is more than the number of entries in the hash table corresponding to the index hash, searching the hash table and the collision FIFO for entries that match the hash key.
